(19) United States
(12) Patent Application Publication
(10) Pub. No.: US 2016/0290806 A1
(43) Pub. Date: Oct. 6, 2016

(54) INFORMATION PROCESSING DEVICE, INFORMATION PROCESSING METHOD, AND COMPUTER PROGRAM PRODUCT

(71) Applicants: Keisuke KONISHI, Kanagawa (JP); Takeo TSUKAMOTO, Kanagawa (JP); Fumio YOSHIZAWA, Kanagawa (JP); Yusuke MATSUSHITA, Kanagawa (JP); Takanori INADOME, Kanagawa (JP); Kenji KAMEYAMA, Kanagawa (JP); Katsuya YAMAMOTO, Kanagawa (JP); Yukio FUJIWARA, Kanagawa (JP); Hideaki ARATANI, Kanagawa (JP); Ryohsuke KAMIMURA, Kanagawa (JP); Hiroto HIGUCHI, Kanagawa (JP); Daisuke HATA, Saitama (JP); Juuta KON, Tokyo (JP); Tomoyo NARITA, Tokyo (JP)

(72) Inventors: Keisuke KONISHI, Kanagawa (JP); Takeo TSUKAMOTO, Kanagawa (JP); Fumio YOSHIZAWA, Kanagawa (JP); Yusuke MATSUSHITA, Kanagawa (JP); Takanori INADOME, Kanagawa (JP); Kenji KAMEYAMA, Kanagawa (JP); Katsuya YAMAMOTO, Kanagawa (JP); Yukio FUJIWARA, Kanagawa (JP); Hideaki ARATANI, Kanagawa (JP); Ryohsuke KAMIMURA, Kanagawa (JP); Hiroto HIGUCHI, Kanagawa (JP); Daisuke HATA, Saitama (JP); Juuta KON, Tokyo (JP); Tomoyo NARITA, Tokyo (JP)

(21) Appl. No.: 15/030,138

(22) PCT Filed: Oct. 20, 2014
(86) PCT No.: PCT/JP2014/078421

§ 371 Date: Apr. 18, 2016

(30) Foreign Application Priority Data
Oct. 22, 2013 (JP) 2013-219659
Aug. 18, 2014 (JP) 2014-166163

(51) Int. Cl. G01C 21/16; G01P 15/00

(52) U.S. Cl. CPC G01C 21/16; G01P 15/00

(57) ABSTRACT

An information processing device includes: a posture change determining unit that determines, based on an output value of an inertial sensor, whether a posture state of a moving object has changed; a reference orientation generating unit that, when it is determined that the posture state of the moving object has changed from a first posture state into a second posture state, generates a reference orientation corresponding to an orientation of the moving object at that time calculated from the output value of the inertial sensor; and an orientation error calculating unit that, when it is determined that the posture state of the moving object has changed from the second posture state into the first posture state, calculates an error of an orientation of the moving object according to the reference orientation, and an orientation at that time calculated from the output value of the inertial sensor.

### TECHNICAL FIELD

The present invention relates to an information processing device, an information processing method, and a computer program product.

### BACKGROUND ART

A positioning technique with autonomous navigation using an inertial sensor is known as a technique for measuring the position or orientation of a pedestrian in a place difficult to receive a signal from a Global Positioning System (GPS) such as an indoor place. For example, various sensors including an acceleration sensor, an angular velocity sensor, and a geomagnetism sensor are used as the inertial sensor. Specifically, in the autonomous navigation, the current position or orientation of the pedestrian is measured by calculating the distance by which and the direction in which the pedestrian has traveled based on the movement of the pedestrian detected using the inertial sensor and integrating the calculated results.

However, there is a possibility in the positioning with the autonomous navigation that the more the integration of the calculated results of the distances or directions is repeated, the more the error is accumulated due to, for example, the effect of the bias included in the results detected with the angular velocity sensor. In addition, the geomagnetism is not stable and it is difficult to correct the orientation with the geomagnetism sensor in the positioning with the autonomous navigation because there is the disturbance in the magnetic field caused, for example, by various electric appliances or structures of buildings.

In light of the foregoing, in these days, there is a technique that previously measures the drift value in the angular velocity sensor of the measuring device based on the gravitational direction (vertically downward) of the pedestrian using the inertial sensor to correct the offset in the angular velocity sensor. There is also a technique that extracts a variation in the previous detected value similar to a variation in the current detected value based on the value previously detected with the inertial sensor of the pedestrian and uses the extracted result to calculate the reference value that is referenced to correct the current detected value.

However, the existing techniques described above have a problem in that it is difficult to accurately determine the orientation of a moving object such as a pedestrian. For example, the drift value in the angular velocity sensor varies depending on the temperature or time on that occasion, and thus, when a moving object is positioned without walking for a long time, an error from the previous offset value occur, and the error is accumulated in the integration of the calculation results with the angular velocity sensor. Even when the current detected value is similar to the previous detected value, the offset values of the inertial sensor are different and there is a possibility that the reference value is not preferable when the orientations of the pedestrian are different.

In light of the foregoing, there is a need to provide an information processing device, information processing method, and a computer program product that can more accurately determine the orientation when a moving object starts moving even when the positioning has been performed for a long time.

### SUMMARY OF THE INVENTION

An information processing device includes: a posture change determining unit that determines, based on an output value of an inertial sensor, whether a posture state of a moving object has changed; a reference orientation generating unit that, when it is determined that the posture state of the moving object has changed from a first posture state into a second posture state different from the first posture state, generates a reference orientation corresponding to a first orientation of the moving object when the state has changed into the second posture state, the first orientation being calculated from the output value of the inertial sensor; and an orientation error calculating unit that, when it is determined that the posture state of the moving object has changed from the second posture state into the first posture state, calculates an error of an orientation of the moving object when the state has changed into the first posture state according to the reference orientation, and a second orientation of the moving object when the state has changed into the first posture state, the second orientation being calculated from the output value of the inertial sensor.

### BRIEF DESCRIPTION OF DRAWINGS

FIG. 1 is a diagram of an exemplary hardware configuration of an information processing device according to a first embodiment.

FIG. 2 is a functional block diagram of an exemplary configuration of the information processing device according to the first embodiment.

FIG. 3 is a diagram of exemplary variation in the vertical acceleration when a posture state changes.

FIG. 4 is a flowchart of a flow of a reference orientation determining process according to the first embodiment.

FIG. 5 is a diagram of exemplary variation in the vertical acceleration when the posture state changes in an exemplary modification of the first embodiment.

FIG. 6 is a flowchart of an exemplary flow of the reference orientation determining process according to the exemplary modification of the first embodiment.

FIG. 7 is a functional block diagram of an exemplary configuration of an information processing device according to a second embodiment.

FIG. 8 is a flowchart of an exemplary flow of a reference orientation determining process according to the second embodiment.

FIG. 9 is a functional block diagram of an exemplary configuration of an information processing device according to a third embodiment.

FIG. 10A is a diagram of exemplary variation in the vertical acceleration and angular velocity when the posture state changes.

FIG. 10B is a diagram of exemplary variation in the vertical acceleration and angular velocity when the posture state changes.

FIG. 11 is a flowchart of an exemplary flow of a reference orientation determining process according to the third embodiment.

FIG. 12 is a diagram of an exemplary configuration of a positioning system including a server device.

FIG. 13 is a functional block diagram of exemplary configuration of a mobile terminal device and a server device included in the positioning system.

### DESCRIPTION OF EMBODIMENTS

The embodiments of the information processing device, the information processing method, and the computer program product according to the present invention will be described hereinafter with reference to the appended drawings. Note that the present invention is not limited to the embodiments to be described below. The embodiments can appropriately be combined with each other as long as no conflict arises in the contents. An example in which the moving object is a person (user) will be described in each of the embodiments.

### First Embodiment

### Hardware Configuration

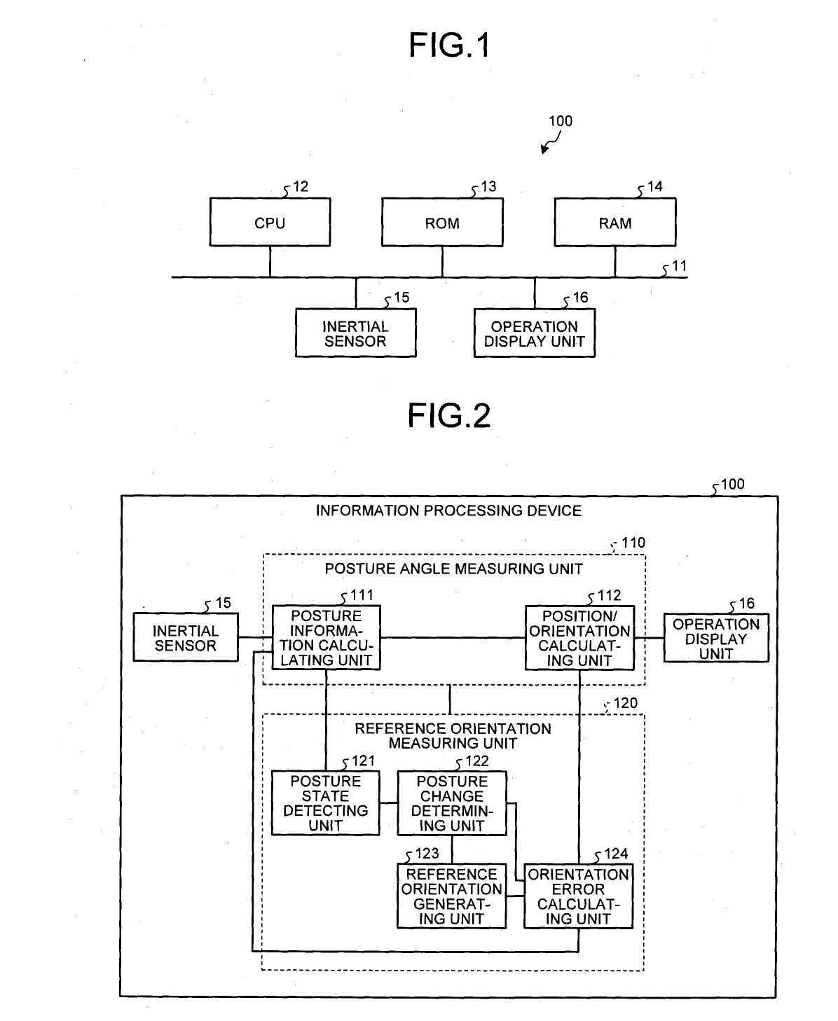

The hardware configuration of an information processing device according to a first embodiment will be described using FIG. 1. FIG. 1 is a diagram of an exemplary hardware configuration of the information processing device according to the first embodiment.

As illustrated in FIG. 1, the information processing device 100 includes a Central Processing Unit (CPU) 12, a Read Only Memory (ROM) 13, a Random Access Memory (RAM) 14, an inertial sensor 15, and an operation display unit 16 that are connected to each other through a bus 11. For example, the information processing device 100 is a mobile terminal device such as a smartphone that the user possesses or a dedicated terminal device for positioning the user.

Among them, the CPU 12 controls the entire information processing device 100. The ROM 13 stores a program or various types of data used in processing executed according to the control of the CPU 12. The RAM 14 temporarily stores, for example, the data used in processing executed according to the control of the CPU 12. The inertial sensor 15 includes various sensors used for positioning. Examples of the inertial sensor 15 include an acceleration sensor, an angular velocity sensor, and a geomagnetism sensor. The operation display unit 16 receives an input operation from the user, and displays various types of information to the user. For example, the operation display unit 16 is a touch panel. Note that the information processing device 100 can include a communication unit for communicating with another device.

### Device Configuration According to First Embodiment

Next, the information processing device according to the first embodiment will be described using FIG. 2. FIG. 2 is a functional block diagram of an exemplary configuration of the information processing device according to the first embodiment.

As illustrated in FIG. 2, the information processing device 100 includes the inertial sensor 15, the operation display unit 16, a posture angle measuring unit 110, and a reference orientation measuring unit 120. The information processing device 100 determines, for example, the position or orientation of the user. Among them, the posture angle measuring unit 110 includes a posture information calculating unit 111, and a position/orientation calculating unit 112. The reference orientation measuring unit 120 includes a posture state detecting unit 121, a posture change determining unit 122, a reference orientation generating unit 123, and an orientation error calculating unit 124. Some or all of the components described above may be software (a program), or a hardware circuit.

Next, the entire configuration of the present embodiment will be described. An objective of the present embodiment is to correct the orientation of the user when the user stands up again using when the user sits on a chair as a reference, and to use the amount of error of the orientation at that time as the offset value so as to suppress the deviation of the orientation of the user. More specifically, based on various sensor values output from the inertial sensor 15, the posture angle measuring unit 110 calculates the current posture information and orientation of the user. Here, the posture information of the user indicates the posture angle of the user using the gravitational direction as a reference or the value of each of the sensors. At that time, based on the posture information of the user calculated with the posture angle measuring unit 110, the reference orientation measuring unit 120 determines the posture state of the user, generates a reference orientation when the user sits on a chair, and calculates the amount of error from the reference orientation when the user stands up again. Then, based on the amount of error of the orientation calculated with the reference orientation measuring unit 120, the orientation of the user in the posture angle measuring unit 110 is corrected, and the deviation of the orientation of the user is suppressed using the amount of error of the orientation as the offset value. Each of the components will be described hereinafter.

The inertial sensor 15 includes various sensors installed on a smartphone or the like. For example, the inertial sensor 15 includes, for example, an acceleration sensor, an angular velocity sensor, and a geomagnetism sensor, and outputs the detected sensor value. The operation display unit 16 receives an input operation from the user and displays various types of information to the user. As described above, the operation display unit 16 is, for example, a touch panel. For example, the operation display unit 16 receives the input operation for starting positioning the user, and displays the positioning results, for example, of the position and orientation of the user.

The posture angle measuring unit 110 calculates, for example, the position, orientation, and posture angle of the user based on the sensor values output from the inertial sensor 15. The positioning results obtained from the calculations of the position and orientation with the posture angle measuring unit 110 are output to the operation display unit 16 and the reference orientation measuring unit 120. The positioning results can be output not only to the operation display unit 16 and the reference orientation measuring unit 120 but also to an external device. When the positioning results are output to an external device, a communication unit (communication interface) for connecting to a network such as the Internet is used.

The posture information calculating unit 111 calculates the posture angle of the user and the sensor value on a coordinate system using the gravitational direction as a reference according to the sensor value output from the inertial sensor 15. More specifically, the posture information calculating unit 111 finds a gravitational direction (vertically downward) vector according to the acceleration vector output from the acceleration sensor and the angular velocity vector output from the angular velocity sensor. Then, the posture information calculating unit 111 calculates the posture angle of the user according to the gravitational direction vector, and the angular velocity vector or the magnetic direction vector output from the geomagnetism sensor. When the posture angle of the user is calculated, it is assumed that the rotation angle about a vertical axis of the information processing device 100 is the yaw angle, the rotation angle about an axis perpendicular to the vertical direction and in the left and right direction is the pitch angle, and the rotation angle about an axis perpendicular to the vertical direction and in the front and back direction is the roll angle. Then, the posture information calculating unit 111 calculates the posture angles of the user denoted with the yaw angle, the pitch angle, and the roll angle using the gravitational direction as a reference.

The posture information calculating unit 111 further performs a coordinate transformation of the sensor values output from the inertial sensor 15 to the coordinate system using the gravitational direction as a reference based on the calculated posture angle of the user. More specifically, the posture information calculating unit 111 calculates the rotation matrix to the coordinate system using the gravitational direction as a reference from the yaw angle, pitch angle, and roll angle using the gravitational direction as a reference that are calculated in the posture information calculating unit 111. Then, the sensor values output from the inertial sensor 15 is rotated with the rotation matrix to calculate the sensor values on the coordinate system using the gravitational direction as a reference.

The posture information calculating unit 111 receives the error of the orientation accumulated due to the positioning from the reference orientation measuring unit 120, and calculates the offset value to correct the posture angle calculated based on the sensor value output from the inertial sensor 15. Then, the posture information calculating unit 111 corrects the posture angle based on the calculated offset value. After that, the posture information calculating unit 111 outputs the posture angle corrected with the offset value and the sensor values after the coordinate transformation to the position/orientation calculating unit 112 and the posture state detecting unit 121.

The position/orientation calculating unit 112 calculates the position and orientation of the user. More specifically, the position/orientation calculating unit 112 receives the posture angle output from the posture information calculating unit 111 and the sensor values after the coordinate transformation. Then, the position/orientation calculating unit 112 calculates the acceleration vector generated due to the walking motion of the user. Subsequently, the position/orientation calculating unit 112 analyzes and detects the walking motion from the acceleration vector generated due to the walking motion.

After that, based on the detected result, the position/orientation calculating unit 112 measures the magnitude of the walking motion based on the gravity acceleration vector and the acceleration vector generated due to the walking motion, and converts the measured result into the stride. Then, the position/orientation calculating unit 112 finds the relative displacement vector from a reference position by integrating the posture angle and the stride. The found relative displacement vector is the positioning result indicating the position and orientation of the user. The position/orientation calculating unit 112 outputs the positioning result to the operation display unit 16 and to the orientation error calculating unit 124.

The reference orientation measuring unit 120 generates the reference orientation according to the posture state of the user, and calculates the error of the orientation of the user according to the reference orientation and the orientation of the user. The error of the orientation of the user calculated with the reference orientation measuring unit 120 is output to the posture angle measuring unit 110. Note that the reference orientation will be described in detail below.

The posture state detecting unit 121 detects the posture state of the user. More specifically, the posture state detecting unit 121 detects the posture state of the user that is in a standing state or a non-standing state based on the sensor values after the coordinate transformation output from the posture information calculating unit 111. Here, the non-standing state indicates a state in which the user does not stand (does not move on foot), for example, a state in which the user sits on a chair, a floor, a ground, or the like, or a state in which the user lies on a floor or a ground. The posture state is detected based on the vertical component of the acceleration of the information processing device 100 (hereinafter, referred to as “vertical acceleration”) in an aspect. For example, when the user sits down on the chair from the standing state (including a state in which the user is in walking), or when the user stands up from the state in which the user sits on the chair, a predetermined characteristic appears in the variation in the vertical acceleration. Then, the posture state detecting unit 121 outputs the detected posture state to the posture change determining unit 122. Note that the standing state is an exemplary first posture state. The non-standing state is an exemplary second posture state.

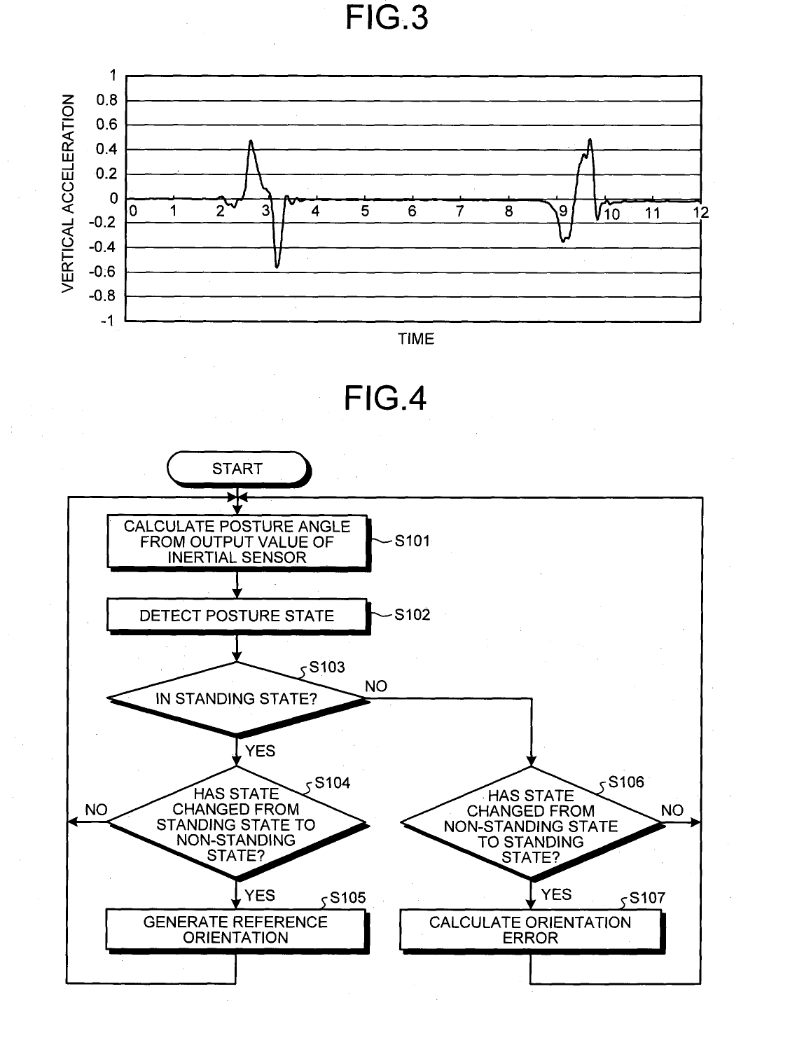

The posture change determining unit 122 determines, based on the posture state, whether the posture state of the user has changed. FIG. 3 is a diagram of exemplary variation in the vertical acceleration when the posture state changes. In FIG. 3, the vertical acceleration is shown on the vertical axis, and the time is shown on the horizontal axis. In FIG. 3, the vertical acceleration is filtered with a Low Pass Filter (LPF) such that the predetermined characteristic appearing when the posture state changes is easy to find. As illustrated in FIG. 3, the value of the vertical acceleration varies in a positive direction first and then varies largely in a negative direction from around 2 seconds. The variation in the vertical acceleration indicates, for example, that the user gets into a standing state from the state in which the user sits on the chair. The value of the vertical acceleration varies in a negative direction first and then varies largely in a positive direction from around 9 seconds. The variation in the vertical acceleration indicate, for example, that the user gets into a state in which the user sits on a chair from the standing state. The posture change determining unit 122 determines, from the temporal variation in the vertical acceleration illustrated in FIG. 3, that the user stands up from the sitting state or sits down from the standing state. Then, the posture change determining unit 122 outputs the determination results of the posture state to the reference orientation generating unit 123 and the orientation error calculating unit 124.

The reference orientation generating unit 123 generates the reference orientation. More specifically, when the posture change determining unit 122 determines that the posture state of the user has changed from the standing state to the sitting state, the reference orientation generating unit 123 generates the reference orientation corresponding to the orientation of the user when the state has changed into the sitting state. The orientation of the user when the state has changed into the sitting state can be obtained from the position/orientation calculating unit 112. The reference orientation is generated (updated) every time the posture state of the user gets into a sitting state from a standing state. The generated (updated) reference orientation is appropriately used in the orientation error calculating unit 124.

The orientation error calculating unit 124 calculates the error of the orientation of the user. More specifically, when the posture change determining unit 122 determines that the posture state of the user has changed from the sitting state to the standing state, the orientation error calculating unit 124 obtains the orientation of the user when the state has changed into the standing state from the position/orientation calculating unit 112. In other words, the orientation error calculating unit 124 obtains the current orientation of the user from the position/orientation calculating unit 112. Then, the orientation error calculating unit 124 calculates the error of the orientation of the user when the state has changed into the standing state according to the reference orientation generated with the reference orientation generating unit 123, and the current orientation of the user. After that, the orientation error calculating unit 124 outputs the calculated error of the orientation to the posture information calculating unit 111.

The orientation when the user sits on a chair is used as the reference orientation in the present embodiment on the assumption that the variation in the orientation of the user is slight even when the standing user sits down on the chair and stands up again. There is a possibility that the orientation when the user stands up again includes an error due to the integration. Thus, the error between the reference orientation and the orientation when the user stands up again is calculated and is used for calculating the offset value used for suppressing the deviation of the orientation of the user. In other words, the present embodiment can prevent the orientation determined when the user starts moving from largely deviating owing to the orientation being not accurately determined and the error being accumulated when the user stays at an absolute position that is a reference and is a place to which a radio wave does not reach, for a long time.

### Flow of Reference Orientation Determining Process According to First Embodiment

Next, a flow of the reference orientation determining process according to the first embodiment will be described using FIG. 4. FIG. 4 is a flowchart of an exemplary flow of the reference orientation determining process according to the first embodiment. Note that the reference orientation determining process is a process performed mainly with the reference orientation measuring unit 120.

As illustrated in FIG. 4, the posture information calculating unit 111 calculates the posture angle of the user according to the sensor values output from the inertial sensor 15 and calculates the offset value based on the error of the orientation calculated with the orientation error calculating unit 124 to calculate the posture angle corrected with the offset value (step S101). The posture state detecting unit 121 detects the posture state of the user that is in a standing state or a non-standing state based on the posture angle calculated with the posture information calculating unit 111 and the sensor values after the coordinate transformation (step S102).

When the posture state detected with the posture state detecting unit 121 is a standing state (step S103: Yes), the posture change determining unit 122 determines based on the temporal variation in the vertical acceleration whether the state has changed from the standing state to the non-standing state (step S104). When the posture change determining unit 122 determines at that time that the state has changed from the standing state to the non-standing state (step S104: Yes), the reference orientation generating unit 123 generates the reference orientation corresponding to the orientation of the user when the state has changed into the non-standing state (step S105). When a reference orientation has been generated already at that time, the reference orientation generating unit 123 updates the reference orientation to the newly-generated reference orientation. Furthermore, the process in step S101 is performed again after the generation of the reference orientation. On the other hand, when the posture change determining unit 122 determines that the state has not changed from the standing state to the non-standing state (step S104: No), the process in step S101 is performed again.

Alternatively, when the posture state detected with the posture state detecting unit 121 is a non-standing state (step S103: No), the posture change determining unit 122 determines, based on the temporal variation in the vertical acceleration, whether the state has changed from the non-standing state to a standing state (step S106). When the posture change determining unit 122 determines at that time that the state has changed from the non-standing state to the standing state (step S106: Yes), the orientation error calculating unit 124 obtains the current orientation of the user from the position/orientation calculating unit 112 to calculate the error of the orientation of the user (the orientation error) according to the reference orientation generated with the reference orientation generating unit 123 and the current orientation of the user (step S107). After the orientation error is calculated, the process in step S101 is performed again. On the other hand, when the posture change determining unit 122 determines that the state has not changed from the non-standing state to the standing state (step S106: No), the process in step S101 is performed again.

### Effect of First Embodiment

The information processing device 100 uses the orientation when the user gets into a non-standing state from a standing state as the reference orientation, and uses the error between the reference orientation and the orientation when the user gets in the standing state for offset correction. As a result, the information processing device 100 can more accurately determine the orientation when the user stands up and starts moving.

### Exemplary Modification of First Embodiment

In the first embodiment, the case in which the orientation when the user gets into the non-standing state from the standing state is used as the reference orientation has been described. In the exemplary modification of the first embodiment, a case in which the orientation when the user gets into a non-walking state from a walking state is used as the reference orientation will be described. Note that the device configuration in the exemplary modification of the first embodiment is similar to the information processing device 100 in the first embodiment. Hereinafter, the functions different from those in the information processing device 100 according to the first embodiment will be described.

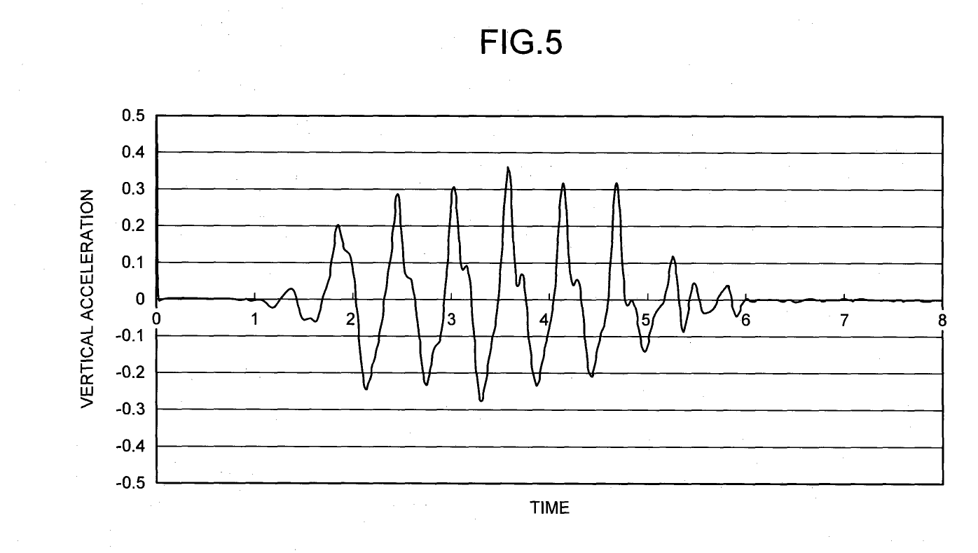

FIG. 5 is a diagram of exemplary variation in the vertical acceleration when the posture state changes according to the exemplary modification of the first embodiment. For example, FIG. 5 illustrates that the user gets into a state in which the user is in walking (in a walking state) from a state in which the user is at rest (in a non-walking state). The posture change determining unit 122 determines, according to the temporal variation in the vertical acceleration illustrated in FIG. 5, that the user walks from a rest state or stops from a walking state. Then, the posture change determining unit 122 outputs the determination result of the posture state to the reference orientation generating unit 123 and the orientation error calculating unit 124.

When the posture change determining unit 122 determines that the posture state of the user has changed from a walking state into a rest state, the reference orientation generating unit 123 generates the reference orientation corresponding to the orientation of the user when the state has changed into the rest state. The orientation of the user when the state has changed into the rest state can be obtained from the position/orientation calculating unit 112. The reference orientation is generated (updated) every time the posture state of the user changes from a walking state into a non-walking state. The generated (updated) reference orientation is appropriately used in the orientation error calculating unit 124.

When the posture change determining unit 122 determines that the posture state of the user has changed from a rest state into a walking state, the orientation error calculating unit 124 obtains the orientation of the user when the state has changed into the walking state from the position/orientation calculating unit 112. In other words, the orientation error calculating unit 124 obtains the current orientation of the user from the position/orientation calculating unit 112. Then, the orientation error calculating unit 124 calculates the error of the orientation of the user when the state has changed into the walking state according to the reference orientation generated with the reference orientation generating unit 123 and the current orientation of the user. After that, the orientation error calculating unit 124 outputs the calculated error of the orientation to the posture information calculating unit 111.

### Flow of Reference Orientation Determining Process According to Exemplary Modification of First Embodiment

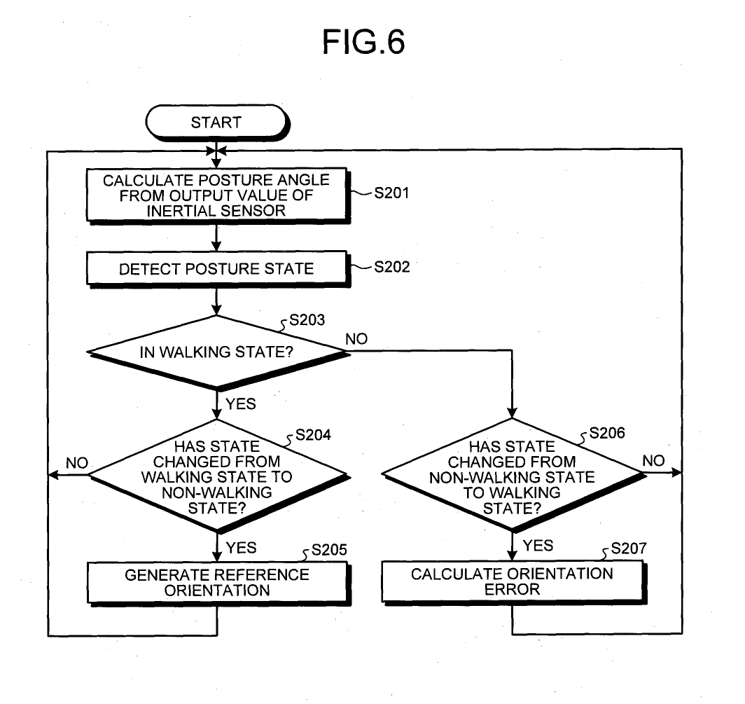

Next, a flow of the reference orientation determining process according to an exemplary modification of the first embodiment will be described using FIG. 6. FIG. 6 is a flowchart of an exemplary flow of the reference orientation determining process according to an exemplary modification of the first embodiment.

As illustrated in FIG. 6, the posture information calculating unit 111 calculates the posture angle of the user according to the sensor values output from the inertial sensor 15, and calculates the offset value based on the error of the orientation calculated with the orientation error calculating unit 124 to calculate the posture angle corrected with the offset value (step S201). The posture state detecting unit 121 detects the posture state of the user that is in a walking state or a non-walking state based on the posture angle calculated with the posture information calculating unit 111 and the sensor values after the coordinate transformation (step S202).

When the posture state detected with the posture state detecting unit 121 is a walking state (step S203: Yes), the posture change determining unit 122 determines, based on the temporal variation in the vertical acceleration, whether the state has changed from the walking state into a non-walking state (step S204). When the posture change determining unit 122 determines that the state has changed from the walking state into a non-walking state (step S204: Yes), the reference orientation generating unit 123 generates the reference orientation corresponding to the orientation of the user when the state has changed into the non-walking state (step S205). When a reference orientation has been generated already at that time, the reference orientation generating unit 123 updates the reference orientation to the newly-generated reference orientation. Furthermore, the process in step S201 is performed again after the generation of the reference orientation. On the other hand, when the posture change determining unit 122 determines that the state has not changed from the walking state to a non-walking state (step S204: No), the process in step S201 is performed again.

Alternatively, when the posture state detected with the posture state detecting unit 121 is a non-walking state (step S203: No), the posture change determining unit 122 determines, based on the temporal variation in the vertical acceleration, whether the state has changed from the non-walking state to a walking state (step S206). When the posture change determining unit 122 determines at that time that the state has changed from the non-walking state to the walking state (step S206: Yes), the orientation error calculating unit 124 obtains the current orientation of the user from the position/orientation calculating unit 112 to calculate the error of the orientation of the user (the orientation error) according to the reference orientation generated with the reference orientation generating unit 123 and the current orientation of the user (step S207). After the orientation error is calculated, the process in step S201 is performed again. On the other hand, when the posture change determining unit 122 determines that the state has not changed from the non-standing state to the standing state (step S206: No), the process in step S201 is performed again.

### Effect of Exemplary Modification of First Embodiment

The information processing device 100 uses the orientation when the user gets into a non-walking state (for example, a rest state) from a walking state as the reference orientation, and uses the error between the reference orientation and the orientation when the user gets in the standing state for offset correction. As a result, the information processing device 100 can more accurately determine the orientation when the user gets into a walking state from a non-walking state and starts moving.

### Second Embodiment

In the first embodiment, the case in which the orientation when the user gets into the non-standing state from the standing state is used as the reference orientation has been described. In a second embodiment, a case in which the reference orientation is updated during a non-standing state will be described.

### Device Configuration in Second Embodiment

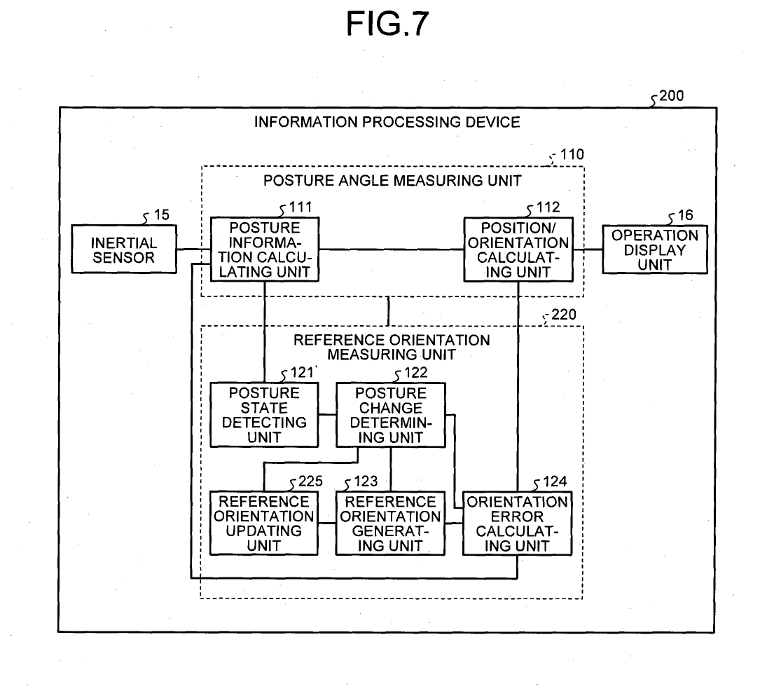

The configuration of an information processing device according to the second embodiment will be described using FIG. 7. FIG. 7 is a functional block diagram of an exemplary configuration of the information processing device according to the second embodiment. In the second embodiment, the same components as in the first embodiment will be denoted with the same reference signs and the descriptions of the same components may be omitted. Specifically, the functions, components, and processes other than a reference orientation updating unit 225 to be described below are the same as in the first embodiment.

As illustrated in FIG. 7, an information processing device 200 includes an inertial sensor 15, an operation display unit 16, a posture angle measuring unit 110, and a reference orientation measuring unit 220. Among them, the posture angle measuring unit 110 includes a posture information calculating unit 111 and a position/orientation calculating unit 112. The reference orientation measuring unit 220 includes a posture state detecting unit 121, a posture change determining unit 122, a reference orientation generating unit 123, an orientation error calculating unit 124, and a reference orientation updating unit 225.

The reference orientation updating unit 225 updates the reference orientation generated with the reference orientation generating unit 123 during a non-standing state. More specifically, the reference orientation updating unit 225 determines whether the variation in the sensor value output from the inertial sensor 15 becomes equal to or larger than a predetermined amount of variation during a situation in which the posture change determining unit 122 determines that the posture state of the user has changed from the standing state to the sitting state. For example, the variation in the sensor value is the variation in the angular velocity. In other words, the reference orientation updating unit 225 determines whether the orientation of the user during sitting has changed by determining whether the variation in the angular velocity of the information processing device 200 becomes equal to or larger than a predetermined amount of variation during a state in which the user sits on a chair or the like.

When the variation in the angular velocity becomes equal to or larger than the predetermined amount of variation, the reference orientation updating unit 225 updates the reference orientation generated with the reference orientation generating unit 123 to the orientation of the user when the variation in the angular velocity becomes equal to or larger than the predetermined amount of variation. For example, the predetermined amount of variation is a larger value than the drift of the angular velocity sensor, and at least a value from which the fact that the orientation of the user has changed can be detected. Note that the reference orientation updating unit 225 updates the reference orientation every time the variation in the angular velocity becomes equal to or larger than the predetermined amount of variation during the non-standing state. The reference orientation updated as described above is used in the process with the orientation error calculating unit 124, similarly to the first embodiment.

In the present embodiment, the orientation when the user sits down on a chair is used as the reference orientation, and the reference orientation is updated in consideration of the orientation changed during a state in which the user sits on a chair. The error between the updated reference orientation and the orientation when the user stands up again is calculated such that the error is used for calculating the offset value for suppressing the deviation of the orientation of the user.

### Flow of Reference Orientation Determining Process According to Second Embodiment

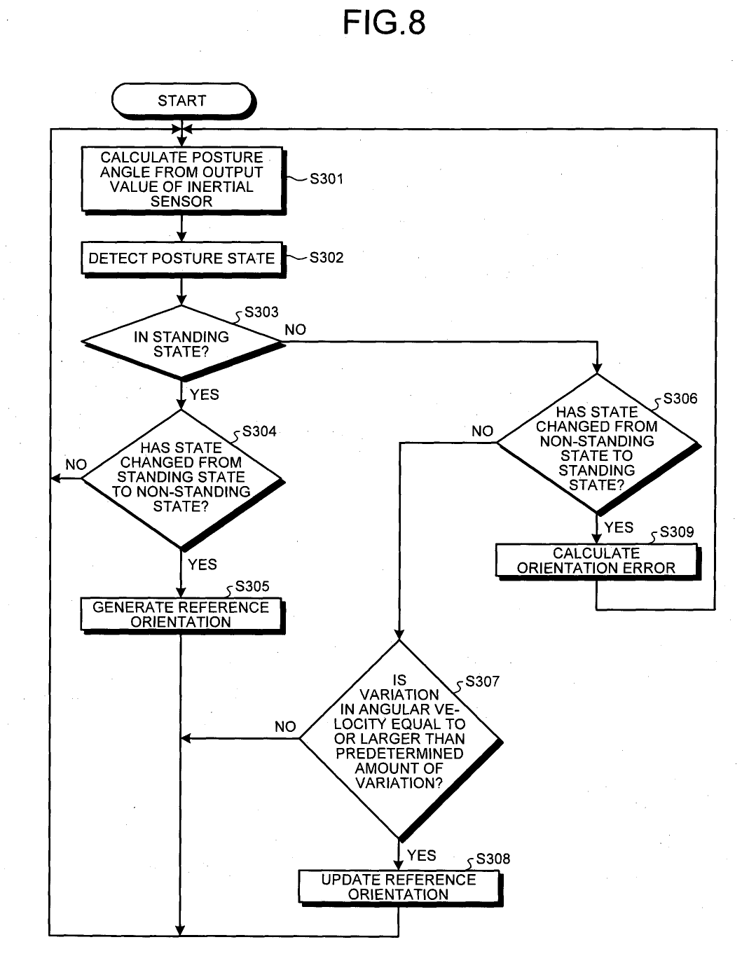

Next, a flow of the reference orientation determining process according to the second embodiment will be described using FIG. 8. FIG. 8 is a flowchart of an exemplary flow of the reference orientation determining process according to the second embodiment. Note that the detailed descriptions of the same processes as in the flow of the reference orientation determining process according to the first embodiment will be omitted. Specifically, the processes in step S301 to step S305 are the same as the processes in step S101 to step S105.

As illustrated in FIG. 8, when the posture state detected with the posture state detecting unit 121 is a non-standing state (step S303: No), the posture change determining unit 122 determines based on the temporal variation in the vertical acceleration whether the state has changed from a non-standing state to the standing state (step S306). When the posture change determining unit 122 determines that the state has not changed from the non-standing state to the standing state (step S306: No), the reference orientation updating unit 225 determines whether the variation in the angular velocity output from the inertial sensor 15 is equal to or larger than a predetermined amount of variation (step S307). When determining that the variation in the angular velocity is equal to or larger than the predetermined amount of variation (step S307: Yes), the reference orientation updating unit 225 updates the reference orientation to the orientation when the variation in the angular velocity becomes equal to or larger than the predetermined amount of variation (step S308). After the reference orientation is updated, the process in step S301 is performed again. On the other hand, the reference orientation updating unit 225 determines that the variation in the angular velocity is not equal to or larger than the predetermined amount of variation (step S307: No), the process in step S301 is performed again.

Alternatively, when the posture change determining unit 122 determines that the state has changed from the non-standing state to the standing state (step S306: Yes), the orientation error calculating unit 124 calculates the error of the orientation of the user (the orientation error) according to the reference orientation updated with the reference orientation updating unit 225 and the current orientation of the user (step S309). After the orientation error is calculated, the process in step S301 is performed again. Note that when the reference orientation updating unit 225 has not updated the reference orientation, the reference orientation generated with the reference orientation generating unit 123 is used, similarly to the first embodiment.

### Effect of Second Embodiment

The information processing device 200 uses the orientation when the user gets into a non-standing state from a standing state as the reference orientation, and updates the reference orientation to the orientation when variation in the angular velocity becomes equal to or larger than a predetermined amount of variation during the non-standing state to use the error between the updated reference orientation and the orientation when the user gets into a standing state for offset correction. As a result, the information processing device 200 can more accurately determine the orientation when the user stands up and starts moving.

### Third Embodiment

In the second embodiment, the case in which the orientation when the user gets into a non-standing state from a standing state is used as the reference orientation and, when the variation in the angular velocity becomes equal to or larger than a predetermined amount of variation during the non-standing state, the reference orientation is updated to the orientation at that time has been described. In a third embodiment, a case in which the orientation of the user that varies when the user gets into a non-standing state from a standing state, or when the user gets into a standing state from a non-standing state is reflected on the reference orientation will be described.

### Device Configuration in Third Embodiment

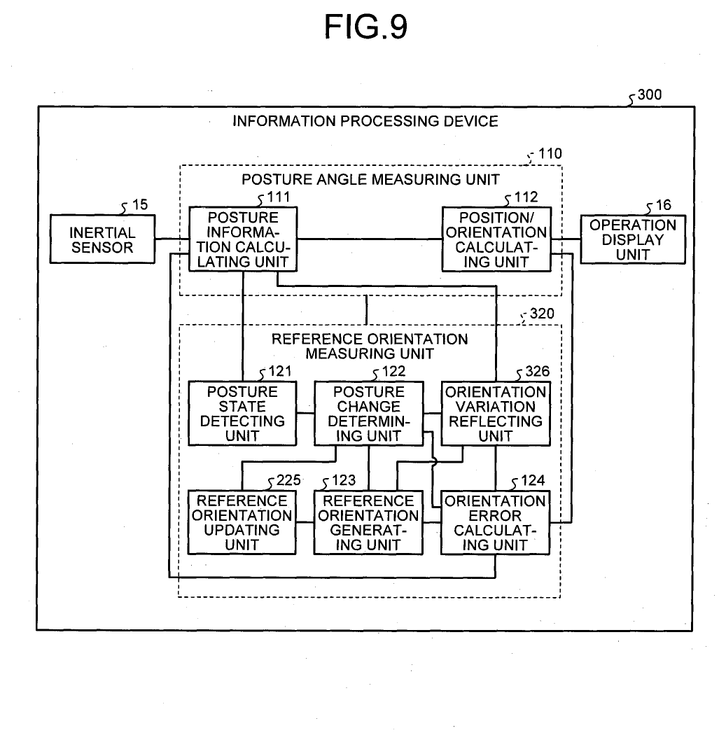

The configuration of an information processing device according to the third embodiment will be described using FIG. 9. FIG. 9 is a functional block diagram of an exemplary configuration of the information processing device according to the third embodiment. In the third embodiment, the same components as in the first embodiment or the second embodiment will be denoted with the same reference signs and the detailed descriptions of the same components may be omitted. Specifically, the functions, components, and processes other than an orientation variation reflecting unit 326 to be described below are the same as in the first embodiment or the second embodiment.

As illustrated in FIG. 9, an information processing device 300 includes an inertial sensor 15, an operation display unit 16, a posture angle measuring unit 110, and a reference orientation measuring unit 320. Among them, the posture angle measuring unit 110 includes a posture information calculating unit 111, and a position/orientation calculating unit 112. The reference orientation measuring unit 320 includes a posture state detecting unit 121, a posture change determining unit 122, a reference orientation generating unit 123, an orientation error calculating unit 124, a reference orientation updating unit 225, and an orientation variation reflecting unit 326.

The orientation variation reflecting unit 326 calculates an amount of the variation in the orientation of the user while the posture state is changing and reflects the amount of variation in the orientation on the reference orientation. More specifically, when the posture change determining unit 122 determines that the posture state of the user has changed from the standing state into the sitting state, the orientation variation reflecting unit 326 obtains the posture angle of the user while the posture state changes from the posture information calculating unit 111. The orientation variation reflecting unit 326 calculates the amount of the variation in the orientation of the user while the user sits on a chair or the like from a standing state according to the obtained posture angle of the user. Subsequently, the orientation variation reflecting unit 326 updates the reference orientation by reflecting the calculated amount of the variation on the reference orientation generated with the reference orientation generating unit 123.

When the posture change determining unit 122 determines whether the posture state of the user has changed from a sitting state to a standing state, the orientation variation reflecting unit 326 obtains the posture angle of the user while the posture state changes from the posture information calculating unit 111. Then, the orientation variation reflecting unit 326 calculates an amount of the variation in the orientation of the user while the user stands up from a state in which the user sits on a chair or the like according to the posture angle of the user. Subsequently, the orientation variation reflecting unit 326 updates the reference orientation by reflecting the calculated amount of the variation in the orientation on the reference orientation generated with the reference orientation generating unit 123. Note that the reference orientation may be updated with the reference orientation updating unit 225 as described in the second embodiment. The reference orientation updated as described above is used in the process with the orientation error calculating unit 124, similarly to the first embodiment or the second embodiment.

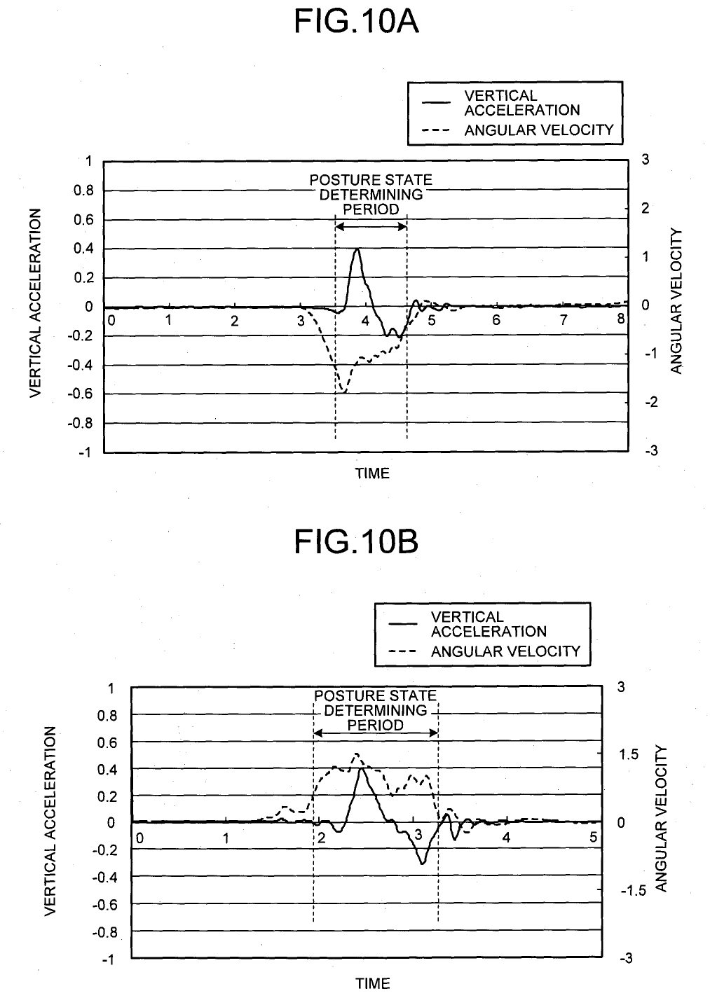

FIG. 10A and FIG. 10B are diagrams of exemplary variation in the vertical acceleration and angular velocity when the posture state changes. In FIG. 10A and FIG. 10B, the vertical acceleration and angular velocity are shown on the vertical axis, and the time is shown on the horizontal axis. Note that the vertical acceleration is represented with a solid line and the angular velocity is represented with a broken line.

As illustrated in FIG. 10A, the value of the vertical acceleration varies in a positive direction first and then varies largely in a negative direction from around 3.5 seconds. The variation in the vertical acceleration indicates, for example, that the user gets into a standing state from a state in which the user sits on a chair. Meanwhile, the value of the angular velocity varies largely in a negative direction from around the time at which three seconds have elapsed. The variation in the angular velocity described above indicates, for example, that the user has changed the posture state in a right direction. In other words, FIG. 10A illustrates an example in which the user has changed the posture state in a right direction while standing up from the sitting state. The orientation variation reflecting unit 326 calculates the amount of the variation in the orientation of the user based on the variation in the angular velocity while the user stands up from a state in which the user sits on a chair (in a “posture state determining period” in FIG. 10A) to reflect the amount on the reference orientation.

As illustrated in FIG. 10B, the value of the vertical acceleration varies in a positive direction first and then varies largely in a negative direction from around the time at which two seconds have elapsed. The variation in the vertical acceleration described above indicate, for example, that the user gets into a standing state from a state in which the user sits on a chair. Meanwhile, the value of the angular velocity varies largely in a positive direction from around 1.5 seconds. This variation in the angular velocity indicates, for example, that the user has changed the posture state in a left direction. In other words, FIG. 10B illustrates an example in which the user has changed the posture state in a left direction while standing up from the sitting state. The orientation variation reflecting unit 326 calculates the amount of the variation in the orientation of the user based on the variation in the angular velocity while the user stands up from a state in which the user sits on a chair (during a “posture state determining period” in FIG. 10B) to reflect the amount on the reference orientation.

In the present embodiment, the orientation when the user sits down on a chair is used as the reference orientation, and the reference orientation is updated in consideration of the amount of the variation in the orientation while the posture state of the user changes. The error between the updated reference orientation and the orientation when the user stands up again is calculated such that the error is used for calculating the offset value for suppressing the deviation of the orientation of the user.

### Flow of Reference Orientation Determining Process According to Third Embodiment

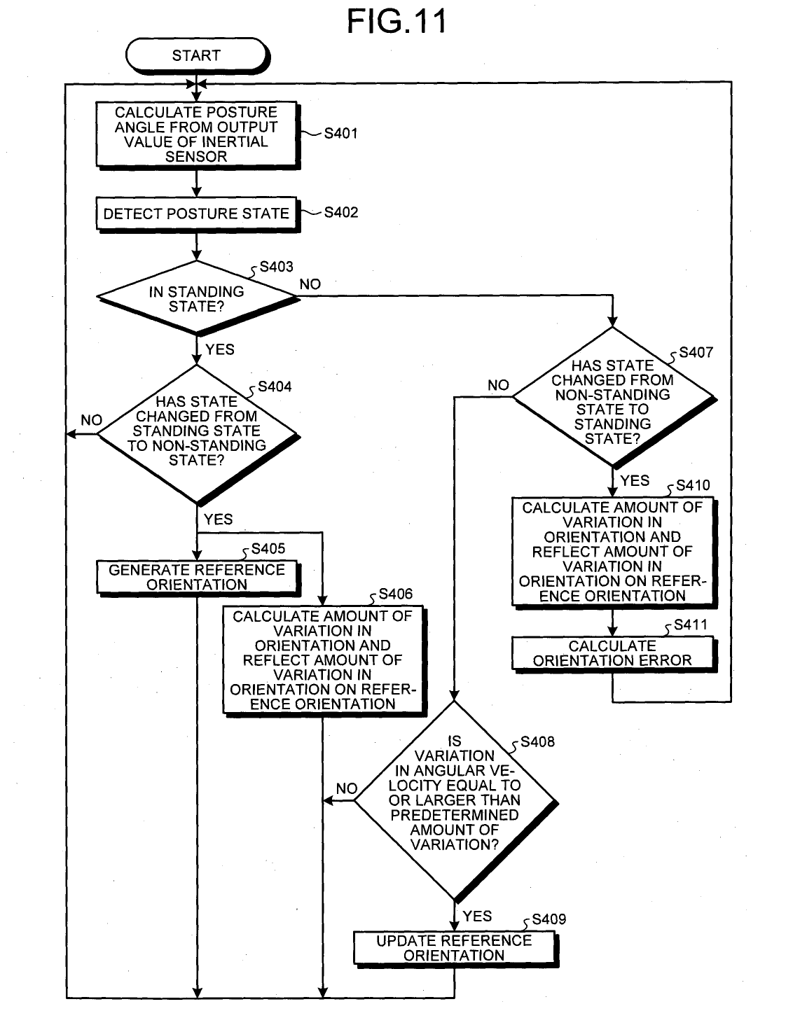

Next, a flow of the reference orientation determining process according to the third embodiment will be described using FIG. 11. FIG. 11 is a flowchart of an exemplary flow of the reference orientation determining process according to the third embodiment. Note that the detailed descriptions of the same processes as in the flow of the reference orientation determining process according to the first embodiment or the second embodiment will be omitted. Specifically, the processes in step S401 to step S405 are the same as the processes in step S101 to step S105. Similarly, the processes in step S408 and step S409 are the same as the processes in step S307 and step S308.

As illustrated in FIG. 11, when the posture change determining unit 122 determines that the state has changed from the standing state to the non-standing state (step S404: Yes), the orientation variation reflecting unit 326 obtains the posture angle of the user while the posture state changes from the posture information calculating unit 111, calculates the amount of the variation in the orientation of the user while the posture state changes, and reflects the calculated amount of the variation in the orientation on the reference orientation generated with the reference orientation generating unit 123 to update the reference orientation (step S406). After the reference orientation is updated, the process in step S401 is performed again.

When the posture change determining unit 122 determines that the state has changed from the non-standing state to the standing state (step S407: Yes), the orientation variation reflecting unit 326 obtains the posture angle of the user while the posture state changes from the posture information calculating unit 111, calculates the amount of the variation in the orientation of the user while the posture state changes, and reflects the calculated amount of the variation in the orientation on the reference orientation generated with the reference orientation generating unit 123 to update the reference orientation (step S410). Note that, when the reference orientation updating unit 225 has updated the reference orientation, the amount of the variation in the orientation is reflected on the reference orientation updated with the reference orientation updating unit 225, similarly to the second embodiment, such that the reference orientation is updated. The orientation error calculating unit 124 calculates the error of the orientation of the user (the orientation error) according to the reference orientation updated with the orientation variation reflecting unit 326 and the current orientation of the user (step S411). After the orientation error is calculated, the process in step S401 is performed again.

### Effect of Third Embodiment

When the user gets into a non-standing state from a standing state, or when the user gets into a standing state from a non-standing state, the information processing device 300 reflects the amount of the variation in the orientation of the user during the posture state determining period on the reference orientation to use, for offset correction, the error between the reference orientation on which the amount of the variation in the orientation is reflected and the orientation when the user gets into the standing state. As a result, the information processing device 300 can more accurately determine the orientation when the user stands up and starts moving.

### Fourth Embodiment

The embodiments of the information processing device according to the present invention have been described above. However, the present invention can be implemented in various different embodiments other than the embodiments described above. So, an embodiment having different (1) configuration and (2) program will be described.

### (1) Configuration

The procedures in the processes, and in control, the specific names, the specific information including various types of data, parameters, and the like that have been described herein above and in the drawings can arbitrarily be changed unless otherwise indicated. Each of the components of the devices illustrated in the drawings is a functional concept and is not necessarily physically be configured as in the drawings. In other words, the specific form of the distribution or integration of the device is not limited to those in the drawings, and all or part thereof can functionally or physically be distributed or integrated in an arbitrary unit depending on various loads or usage conditions.

In each of the embodiments described above, the information processing device has been described as a mobile terminal device such as a smartphone that the user possesses, or a dedicated terminal device for positioning the user. The information processing device can be a server device configured to, perform various processes. Hereinafter, a positioning system that positions the user using a server device will be described.

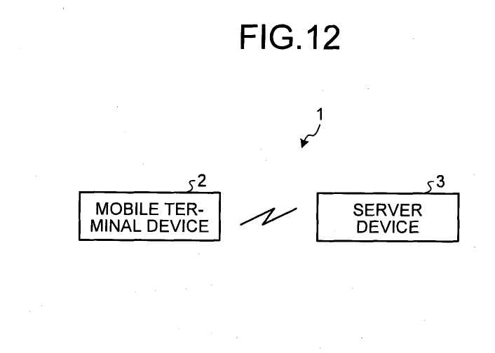

FIG. 12 is a diagram of an exemplary configuration of a positioning system including a server device. As illustrated in FIG. 12, a positioning system 1 includes a mobile terminal device 2, and a server device 3. The mobile terminal device 2 and the server device 3 are connected to a network such as the Internet so as to communicate with each other. Note that the mobile terminal device 2 has a different function from the mobile terminal device (information processing device) described above in the embodiments.

In the configuration described above, the mobile terminal device 2 includes an inertial sensor, and transmits the sensor value detected with the inertial sensor to the server device 3. The server device 3 receives the sensor value transmitted from the mobile terminal device 2, and performs a posture angle determining process or a reference orientation determining process based on the received sensor value. Then, the server device 3 transmits the positioning result to the mobile terminal device 2. The mobile terminal device 2 receives the positioning result from the server device 3 to output and display the received positioning result. In other words, the positioning system 1 according to the present embodiment causes the server device 3 connected to the network to perform the posture angle determining process or the reference orientation determining process described in the embodiments. Note that various functions performed in the posture angle determining process or the reference orientation determining process are not necessarily performed with a single server device 3. The functions may be implemented with a plurality of server devices 3.

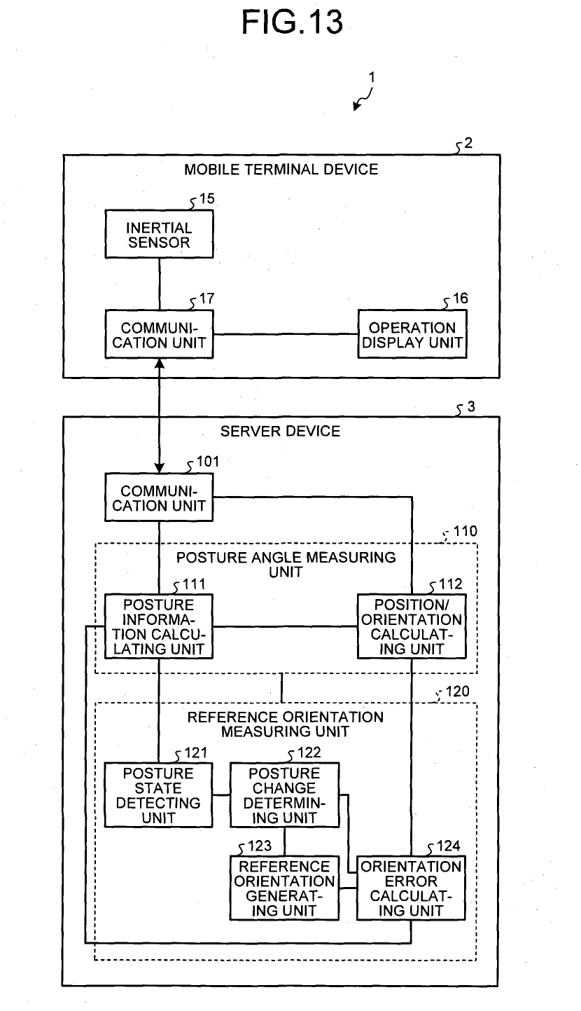

FIG. 13 is a functional block diagram of exemplary configurations of the mobile terminal device 2 and server device 3 included in the positioning system 1. Note that the same functions as in the information processing devices according to the embodiments described above are denoted with the same reference signs in FIG. 13 and the detailed descriptions of the same functions will be omitted.

As illustrated in FIG. 13, the mobile terminal device 2 includes an inertial sensor 15, an operation display unit 16, and a communication unit 17. The server device 3 includes a communication unit 101, a posture angle measuring unit 110, and a reference orientation measuring unit 120. Among them, the posture angle measuring unit 110 includes a posture information calculating unit 111, and a position/orientation calculating unit 112. The reference orientation measuring unit 120 includes a posture state detecting unit 121, a posture change determining unit 122, a reference orientation generating unit 123, and an orientation error calculating unit 124.

The different functions from the information processing devices according to the embodiments described above are the communication unit 17 and the communication unit 101. In other words, the functions for transmitting and receiving the sensor value detected with the inertial sensor 15 and the positioning result calculated with the server device 3 are included in the present embodiment. Note that, although only the same functions in the server device 3 as the information processing device 100 are illustrated in the drawing, the server device 3 can also include the same functions as the information processing device 200 or the information processing device 300. In other words, the server device 3 can also include the reference orientation updating unit 225 and the orientation variation reflecting unit 326.

### (2) Program

As an aspect, an information processing program to be executed in the information processing device 100 is provided while being recorded as a file in an installable or executable format in a computer-readable recording medium such as a CD-ROM, a flexible disk (FD), a CD-R, or a Digital Versatile Disk (DVD). Alternatively, the information processing program to be executed in the information processing device 100 can be stored in a computer connected to a network such as the Internet so as to be provided by a download through the network. Alternatively, the information processing program to be executed in the information processing device 100 can be configured to be provided or distributed through a network such as the Internet. Alternatively, the information processing program can be configured to be provided while being previously embedded in ROM or the like.

The information processing program to be executed in the information processing device 100 has a module configuration including the units described above (the posture change determining unit 122, the reference orientation generating unit 123, and the orientation error calculating unit 124). As actual hardware, a processor (CPU) reads the information processing program from a recording medium and executes the program. This loads each of the units onto the main storage device so as to generate the posture change determining unit 122, the reference orientation generating unit 123, and the orientation error calculating unit 124 on the main storage device.

An embodiment achieves an effect of more accurately determining the orientation of a moving object.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

### REFERENCE SIGNS LIST

100 Information processing device
110 Posture angle measuring unit
111 Posture information calculating unit
112 Position/orientation calculating unit
120 Reference orientation measuring unit
121 Posture state detecting unit
122 Posture change determining unit
123 Reference orientation generating unit
124 Orientation error calculating unit

### CITATION LIST

### Patent Literature

### Patent Literature 1 Japanese Laid-open Patent Publication No. 2013-088280

### Patent Literature 2 WO 2010/001970 A

1. An information processing device comprising:
a posture change determining unit that determines, based on an output value of an inertial sensor, whether a posture state of a moving object has changed;
a reference orientation generating unit that, when it is determined that the posture state of the moving object has changed from a first posture state into a second posture state different from the first posture state, generates a reference orientation corresponding to a first orientation of the moving object when the state has changed into the second posture state, the first orientation being calculated from the output value of the inertial sensor; and
an orientation error calculating unit that, when it is determined that the posture state of the moving object has changed from the second posture state into the first posture state, calculates an error of an orientation of the moving object when the state has changed into the first posture state according to the reference orientation, and a second orientation of the moving object when the state has changed into the first posture state, the second orientation being calculated from the output value of the inertial sensor.

2. The information processing device according to claim 1, further comprising:
a reference orientation updating unit that, when variation in the output value of the inertial sensor becomes equal to or larger than a predetermined amount of variation during the second posture state, updates the reference orientation to a third orientation of the moving object when the variation in the output value becomes equal to or larger than the predetermined amount of variation, the third orientation being calculated from the output value of the inertial sensor.

3. The information processing device according to claim 2, wherein when variation in an angular velocity that is one of the output value of the inertial sensor becomes equal to or larger than a predetermined amount of variation, the reference orientation updating unit updates the reference orientation to the third orientation corresponding to a fourth orientation of the moving object when the variation in the angular velocity becomes equal to or larger than the predetermined amount of variation, the fourth orientation being calculated from the output value of the inertial sensor.

4. The information processing device according to claim 1, further comprising:
an orientation variation reflecting unit that calculates, based on the output value of the inertial sensor, an amount of variation in the orientation of the moving object while the posture state changes, and reflect the amount of variation in the orientation on the reference orientation when it is determined that the posture state of the moving object has changed from the first posture state into the second posture state, or when it is determined that the posture state of the moving object has changed from the second posture state to the first posture state.

5. The information processing device according to claim 1, wherein the first posture state indicates that a posture of the moving object is a standing state, and the second posture state indicates that a posture of the moving object is a non-standing state.

6. The information processing device according to claim 1, wherein the orientation of the moving object calculated based on the output value of the inertial sensor is an orientation corrected based on the error of the orientation of the moving object.

7. An information processing method comprising:
determining, based on an output value of an inertial sensor, whether a posture state of a moving object has changed;
when it is determined that the posture state of the moving object has changed from a first posture state into a second posture state different from the first posture state, generating a reference orientation corresponding to a first orientation of the moving object when the state has changed into the second posture state, the first orientation being calculated from the output value of the inertial sensor; and
when it is determined that the posture state of the moving object has changed from the second posture state into the first posture state, calculating an error of an orientation of the moving object when the state has changed into the first posture state according to the reference orientation, and a second orientation of the moving object when the state has changed into the first posture state, the second orientation being calculated from the output value of the inertial sensor.

8. A computer program product comprising a non-transitory computer-readable medium containing an information processing program, the program causing a computer to perform:
determining, based on an output value of an inertial sensor, whether a posture state of a moving object has changed;
when it is determined that the posture state of the moving object has changed from a first posture state into a second posture state different from the first posture state, generating a reference orientation corresponding to a first orientation of the moving object when the state has changed into the second posture state, the first orientation being calculated from the output value of the inertial sensor; and
when it is determined that the posture state of the moving object has changed from the second posture state into the first posture state, calculating an error of an orientation of the moving object when the state has changed into the first posture state according to the reference orientation, and a second orientation of the moving object when the state has changed into the first posture state, the second orientation being calculated from the output value of the inertial sensor.
